(19) United States
(12) Patent Application Publication
(10) Pub. No.: US 2021/0089229 A1
(43) Pub. Date: Mar. 25, 2021

(54) LOADING MEDIA SETTINGS FROM ON-MEDIA LOCATIONS IN A MEMORY SUB-SYSTEM

(71) Applicant: Micron Technology, Inc., Boise, ID (US)

(72) Inventors: Douglas Eugene Majerus, Boise, ID (US); Scott Anthony Stoller, Boise, ID (US); Brent Carl Byron, Boise, ID (US)

(21) Appl. No.: 16/579,256

(22) Filed: Sep. 23, 2019

(51) Int. Cl. G06F 3/06

(52) U.S. Cl. CPC G06F 3/0659; G06F 3/0604; G06F 3/0653; G06F 3/0673

(57) ABSTRACT

In an embodiment, a system includes a plurality of memory components and a processing device that is operatively coupled with the plurality of memory components. The processing device detects a triggering condition for updating one or more media settings of a memory component of the plurality of memory components, and responsively instructs the memory component to load, from data storage on the memory component, a set of one or more media-setting values that correspond to the one or more media settings of the memory component.

### TECHNICAL FIELD

Embodiments of the disclosure relate generally to memory sub-systems and more specifically to loading media settings from on-media locations in a memory sub-system.

### BACKGROUND

A memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory sub-system in accordance with some embodiments of the present disclosure.

FIG. 2 is a block diagram of an example memory device of the memory sub-system of FIG. 1 in accordance with some embodiments of the present disclosure.

FIG. 3 is a flow diagram of an example method for loading media settings from on-media locations in a memory sub-system in accordance with some embodiments of the present disclosure,

FIG. 4 is a flow diagram depicting some example operations performed by a memory sub-system controller of the memory sub-system of FIG. 1 in accordance with some embodiments of the present disclosure.

FIG. 5 is a message flow diagram depicting communications between, and operations performed by, a memory sub-system controller and multiple memory devices of the memory sub-system of FIG. 1 in accordance with some embodiments of the present disclosure.

FIG. 6 is a block diagram of an example computer system in which embodiments of the present disclosure may operate.

### DETAILED DESCRIPTION

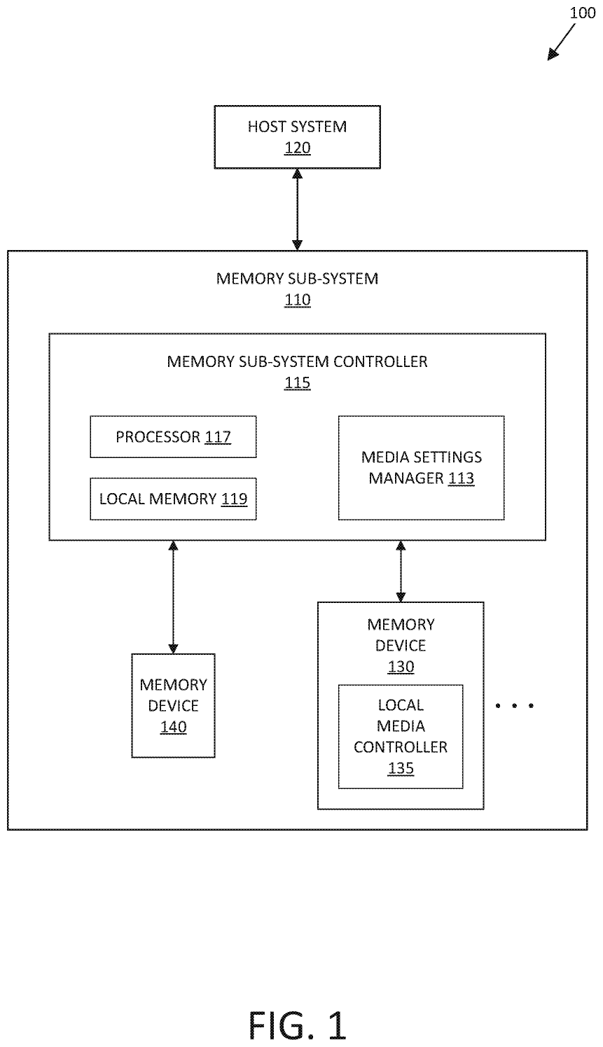

Aspects of the present disclosure are directed to loading media settings from on-media locations in a memory sub-system. A memory sub-system can be a storage device, a memory module, or a hybrid of a storage device and a memory module. Examples of storage devices and memory modules are described below in conjunction with FIG. 1. In general, a host system can utilize a memory sub-system that includes one or more memory components (also hereinafter referred to as “memory devices”). The host system can provide data to be stored at the memory sub-system and can request data to be retrieved from the memory sub-system.

A memory sub-system can further include a memory sub-system controller that can communicate with each of the memory components to perform operations such as reading data, writing data, erasing data, and/or the like at the memory components, perhaps in response to requests received from a host system. Furthermore, one or more of the memory components can include a local media controller to manage the memory cells of the memory component, communicate with the memory sub-system controller on behalf of the memory component, and execute memory requests (e.g., read requests, write requests, and/or the like) that are received from the memory sub-system controller, among other functions. The memory components can include non-volatile memory components such as negative-and-(NAND)-type flash memory. The memory components can include volatile memory components such as random access memory (RAM).

Various aspects of the operation of a given memory component are controlled by settings that are referred to herein as media settings of the memory component. Sets of media settings are referred to herein at times as media-setting solutions, media-settings solutions, or just solutions. Some example media settings include read points (which are also known by other names such as read levels, sensing voltages, and the like), temperature-correction coefficients, program-verify targets, program voltages, threshold voltages, programming operations, processing levels, and the like. As a general matter, to make a given value operative for a given media setting, a memory component performs a function that is referred to herein as “loading” the given value for the given setting. This loading function typically involves the memory component writing the value to a volatile circuit element (e.g., a latch) that is associated in the memory component with the setting. The value in that circuit element then acts as an operational parameter of the memory component.

In current implementations of memory sub-systems, a memory sub-system controller of the memory sub-system manages a number of the media settings of the various memory components of the memory sub-system. In some current implementations, the memory sub-system controller updates the values of one or more memory-sub-system-managed (a.k.a. system-managed) settings by serially sending commands on a media-setting-by-media-setting basis over the one or more controller channels that communicatively link the memory sub-system controller with the memory components. In typical implementations, only one command can be sent per controller channel at a time.

This process typically fully occupies the one or more controller channels until values for all of the system-managed settings have been loaded on all of the memory components in the memory sub-system. In addition to being logistically complex from a memory-sub-system-management standpoint, this process is time-consuming and indeed at boot time can impact the ability of the memory sub-system to meet specifications for performance metrics such as latency, time to ready, and the like, especially for memory sub-systems that contain a relatively large number of memory components. Additionally, performance of the memory sub-system as a whole decreases at times at which media-setting values are transitioned.

Aspects of the present disclosure address the above and other deficiencies by loading media settings from on-media locations in a memory sub-system. In accordance with at least one embodiment, one or more sets of media settings are stored in data storage on a memory component itself. To cause the memory component to load a value for each of one or more media settings, the memory sub-system controller instructs the memory component to load, from the data storage on the memory component, a set of one or more media-setting values that correspond to the one or more media settings of the memory component. In some implementations of the present disclosure, the memory sub-system controller instructs the memory component by transmitting a command (e.g., an op code) to the memory component.

In at least one embodiment, the memory sub-system controller instructs the memory component to load the set of one or more media-setting values in response to detecting a triggering condition such as the elapsing of a periodically expiring timer, the memory component reaching a particular threshold of program/erase counts, the memory component performing a boot-up operation, and/or some other triggering condition. Moreover, in some instances, in addition to instructing the memory component to load the media-setting solution, the memory sub-system controller also transmits to the memory component an indication of a location (e.g., a block and page) on the memory component from which the memory component is to load the media-setting solution. The memory component responsively internally reads and loads the solution, which may have been sent to the memory component at an earlier time by the media-sub-system controller, or which may have been stored in read-only storage on the memory component at an earlier time (such as at the time of manufacture of the memory component or the memory sub-system), among other possible options.

Among the benefits of the present disclosure are that the instruction (e.g., the transmission of a simple load-media-settings command) from the memory sub-system controller to the memory component takes up far less of the available bandwidth on the one or more controller channels than does the current approach of serially sending commands and values for each and every media setting that the memory sub-system controller is instructing the memory component to load in a given media-setting-loading session. Moreover, according to embodiments of the present disclosure, the memory sub-system controller can serially instruct (e.g., send a simple load-media-settings command to) each of multiple memory components, triggering those memory components to begin their own internal media-setting-loading processes in parallel with one another, rather than each serially waiting their turn for a contiguous, dedicated, setting-by-setting session on a controller channel. Furthermore, in instances of the present disclosure in which the controller does send the substantive media-setting values to the memory components, this can be done at uncongested times on the controller channels, rather than right at the moment the controller is instructing the memory component to load one or more media settings, which is the approach of current implementations.

FIG. 1 illustrates an example computing environment 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can be coupled to the memory sub-system 110 via a physical host interface. Examples of a physical host interface include, but are not limited to, a serial advanced technology attachment (S ATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the PCIe interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices memory device 140) can be, but are not limited to, random access memory (RAM), such as dynamic random access memory (DRAM) and synchronous dynamic random access memory (SDRAM).

An example of non-volatile memory devices (e.g., memory device 130) includes a negative-and (NAND) type flash memory. Each of the memory devices 130 can include one or more arrays of memory cells such as single level cells (SLCs), multi-level cells (MLCs), triple level cells (TLCs), or quad-level cells (QLCs). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), negative-or (NOR) flash memory, electrically erasable programmable read-only memory (EEPROM), and a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 115 can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

As depicted in FIG. 1, in at least one embodiment, the memory sub-system controller 115 includes a media settings manager 113, which can take the form of or at least include circuitry, dedicated logic, programmable logic, firmware, software, and/or the like for performing at least the media-settings-manager functions described herein. In some embodiments, the memory sub-system controller 115 includes at least a portion of the media settings manager 113—the processor 117 can be configured to execute instructions stored in local memory 119 for performing the media-settings-manager operations described herein. In some embodiments, the media settings manager 113 is part of the host system 120, an application, or an operating system.

In at least one embodiment, the media settings manager 113 is configured to instruct (e.g., send commands to) the memory devices 130 to update a set of one or more of the media settings of the memory devices 130. Furthermore, the media settings manager 113 can transmit, to the memory devices 130, pages containing media-setting solutions for loading at that time or at a later time by one or more of the memory devices 130. Various functions that are performed by the media settings manager 113 in different combinations in different embodiments are described throughout this disclosure.

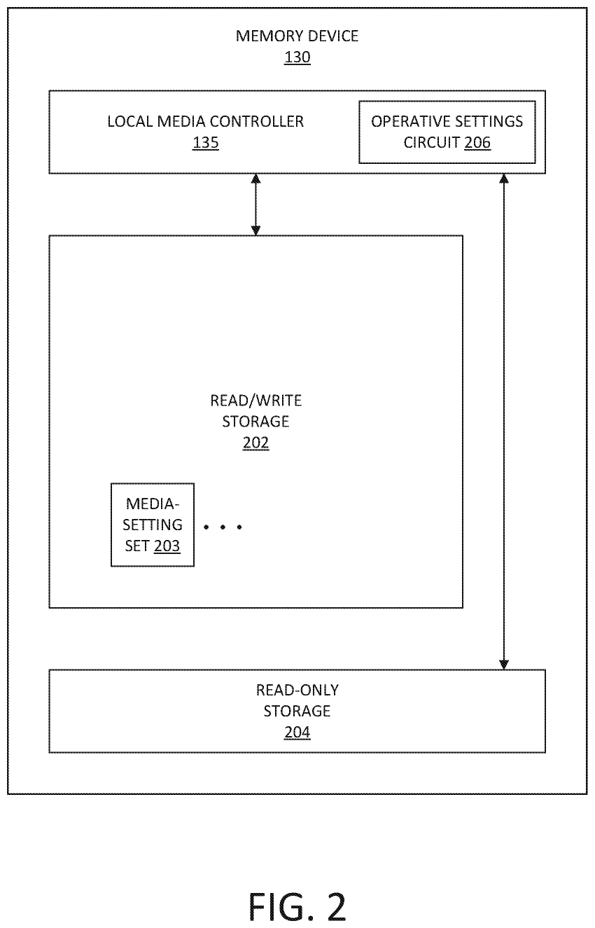

FIG. 2 is a block diagram of a memory device 130. Each of the memory devices 130 can have an internal structure similar to the structure of the memory device 130 that is depicted in and described by way of example in connection with FIG. 2. Moreover, the memory sub-system 110 can include any suitable number of memory devices 130. In one example, the memory sub-system 110 includes 64 memory devices 130; in at least one such embodiment, those 64 memory devices 130 are serviced by 4 controller channels between the memory sub-system controller 115 and the memory devices 130. As mentioned, in at least one embodiment, the memory device 130 includes the local media controller 135. As is further depicted in FIG. 2, in at least one embodiment, the memory device 130 also includes read/write storage 202 and read-only storage 204. As shown in FIG. 2, in implementations of the present disclosure, a set 203 of one or more media settings can be stored in the read/write storage 202. In some instances, multiple sets of media settings can be stored in the read/write storage 202. Also or instead, one of more sets of media settings can be stored in the read-only storage 204. Also, the local media controller 135 includes an operative settings circuit 206. This structure for the memory device 130 is presented by way of example and not limitation, as different structures can be used in different implementations.

In at least one embodiment, the read/write storage 202 includes non-volatile data-storage elements to which the local media controller 135 can write data and from which the local media controller 135 can read data. In an example, the memory device 130 is a NAND-type flash memory component. In at least one embodiment, the read-only storage 204 includes non-volatile data-storage elements from which the local media controller 135 can read data. As an example, the read-only storage 204 may contain data that is provisioned at the time of manufacture of the memory device 130 and/or the memory sub-system 110. In at least one embodiment, the operative settings circuit 206 includes various volatile data-storage elements, such as latches, to which the local media controller 135 loads media-setting values (from, the set 203 of one or more media settings) associated with media settings. Once loaded into the operative settings circuit 206, the values in these volatile data-storage elements control various operational behaviors of the memory device 130.

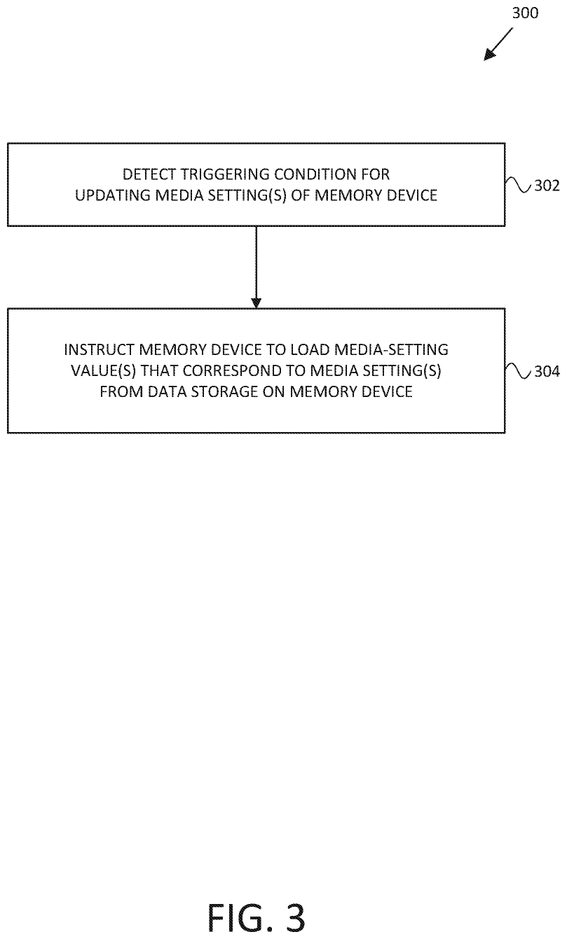

FIG. 3 depicts a flow chart of an example method 300 for loading media settings from on-media locations in a memory sub-system. In at least one embodiment, the method 300 is performed by a memory sub-system such as the memory sub-system 110. Moreover, although shown in a particular sequence, unless otherwise specified, the order of the processes (e.g., operations) in the method 300 can be modified. Thus, the illustrated implementation should be understood only as an example, and it should be understood that the illustrated processes can be performed in a different order, and that some processes can be performed in parallel. Additionally, one or more processes can be omitted in various embodiments. Thus, not all processes are performed in connection with every implementation. Other process flows are possible. Furthermore, the method 300 can be performed by processing logic that can include hardware (e.g., circuitry, dedicated logic, programmable logic, microcode, etc.), software (such as instructions executed on a processing device), firmware, or a combination thereof. In an embodiment, the method 300 is performed by the media settings manager 113 of the memory sub-system controller 115 of the memory sub-system 110. By way of example, the method 300 is described below as being performed by the memory sub-system controller 115 with respect to the memory device 130.

At operation 302, the memory sub-system controller 115 detects a triggering condition for updating one or more media settings of the memory device 130. In some instances, the triggering condition includes the elapsing of a recurring media-settings-refresh timer. That is, the memory sub-system controller 115 may maintain a periodically elapsing timer with respect to one or more of the memory devices 130, and the elapsing of such a timer can be used by the memory sub-system controller 115 as a triggering condition to instruct (e.g., send a load-media-settings command to) the memory device 130 to load a media-settings solution as described herein. Other periodic triggers can be used as well, such as the occurrence of particular clock times and/or the like.

In at least one embodiment, the triggering condition includes the memory device 130 reaching a threshold program/erase-cycle count. The memory sub-system controller 115 may maintain tables for one or more of the various memory devices 130, correlating various count thresholds with various load-media-settings commands, and may send such commands to one or more of the memory devices 130 upon those components reaching their count thresholds. The various memory devices 130 can be configured to report their cycle counts to the memory sub-system controller 115, perhaps periodically and/or upon arriving at or surpassing certain thresholds. Moreover, different media-setting solutions can be selected for different count thresholds. Thus, in at least one embodiment, the memory sub-system controller 115 instructs the memory device 130 to load a particular media-setting solution that is associated with a particular count threshold or milestone most recently reached by the memory device 130.

As another example, the triggering condition may include the memory device 130 performing a boot-up operation. In memory devices 130 that are configured to use latches or other volatile circuit elements for holding the currently operative values of their media settings, these latches or other volatile circuit elements need to have their media-setting values rewritten any time the memory device 130 undergoes a power-cycle or reboot event, either of which results in the memory device 130 performing a boot-up operation.

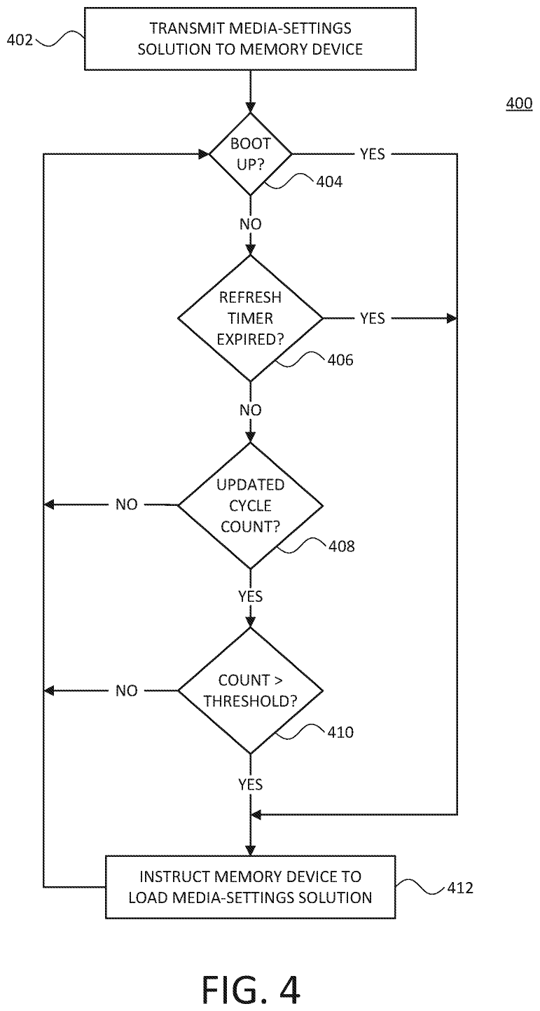

FIG. 4 is a flow diagram of a method 400 that depicts some example operations performed by the memory sub-system controller 115 of the memory sub-system 110 in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the media settings manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more operations can be omitted in various embodiments. Thus, not all operations are required in every embodiment. Other method flows are possible. By way of example, the method 400 is described below as being performed by the memory sub-system controller 115 with respect to the memory device 130.

The three above-mentioned example triggering conditions are addressed in the method 400, along with several other example operations. In at least one embodiment, the method 400 is performed by the memory sub-system controller 115 as at least part of the memory sub-system controller 115 performing the method 300. In some embodiments of the present disclosure, however, performing the method 300 does not involve a complete performing of the method 400, but rather involves performing one or more but not all of the operations of the method 400.

At operation 402, the memory sub-system controller 115 transmits a media-settings solution to the memory device 130. The transmitted media-settings solution could include any suitable number of values for any suitable number of media settings for the memory device 130. In at least one embodiment, the memory sub-system controller 115 performs operation 402 during one or more uncongested periods (e.g., periods of relatively low traffic) on the one or more controller channels between the memory sub-system controller 115 and the memory device 130. The memory sub-system controller 115 can transmit the media-settings solution to the memory device 130 in a single message or in parts across multiple messages.

At operation 404, the memory sub-system controller 115 determines whether or not the memory device 130 has performed a boot-up operation, perhaps within a predefined immediately preceding time period, or perhaps since a previous time that the memory sub-system controller 115 evaluated whether one or more triggering conditions were present for instructing the memory device 130 to load a media-settings solution. In some embodiments, in instances in which the memory sub-system controller 115 instructs or otherwise causes the memory device 130 to reboot, the memory sub-system controller 115 sets a flag that later causes operation 404 to be resolved in the affirmative; in other such embodiments, the memory sub-system controller 115 simply considers operation 404 to be resolved in the affirmative by the action that causes the memory device 130 to reboot. In other instances, the memory sub-system controller 115 resolves operation 404 in the affirmative in cases in which the memory device 130 sends the memory sub-system controller 115 a message or other signal indicating that the memory device 130 has undergone a boot-up operation. If the memory sub-system controller 115 determines at operation 404 that the memory device 130 has performed a boot-up operation, control proceeds to operation 412, which is described below. If not, control proceeds to operation 406.

Thereafter, at operation 406, the memory sub-system controller 115 determines whether or not a media-settings-refresh timer—maintained by the memory sub-system controller 115 in connection with the memory device 130—has expired. In some cases, an entity other than the memory sub-system controller 115 maintains a media-settings-refresh timer associated with the memory device 130 and notifies the memory sub-system controller 115 when that timer expires. In some such cases, it is the memory device 130 itself that maintains this media-settings-refresh timer. Regardless of which device maintains it, the media-settings-refresh timer associated with the memory device 130 could be configured as a periodically elapsing and resetting timer that accordingly causes the memory sub-system controller 115 to instruct the memory device 130 to refresh its media settings at least every certain amount of time. In instances in which the memory sub-system controller 115 instructs the memory device 130 to update/load media settings for a different reason, the memory sub-system controller 115 may reset the media-settings-refresh timer associated with the memory device 130, or send an instruction to another entity to cause that timer to be reset. If the memory sub-system controller 115 determines at operation 406 that a media-settings-refresh timer associated with the memory device 130 has expired, control proceeds to operation 412. If not, control proceeds to operation 408.

The memory sub-system controller 115 determines, see operation 408, whether or not it has received an updated cycle count (e.g., program/erase-cycle count) for the memory device 130 since the previous time (if any) that the memory sub-system controller 115 evaluated the cycle count for the memory device 130. In some embodiments, the memory sub-system controller 115 is configured to query the memory device at regular intervals to ask the memory device 130 to report its current cycle count to the memory sub-system controller 115; in other instances, the memory device 130 is configured to make reports of its current cycle count to the memory sub-system controller 115 periodically and/or upon reaching certain cycle-count thresholds. If the memory sub-system controller 115 determines at operation 408 that it has obtained an updated cycle count for the memory device 130, control proceeds to operation 412. If not, control returns to operation 404.

At operation 410, the memory sub-system controller 115 determines whether the updated cycle count exceeds a particular cycle-count threshold for the memory device 130. It is noted that use here of the term “exceeds” contemplates implementation of the mathematical comparator functions “greater than” or “greater than or equal to.” The memory sub-system controller 115 could maintain one or more cycle-count thresholds in connection with the memory device 130 perhaps specific to the memory device 130, perhaps not. In performing operation 410, the memory sub-system controller 115 could compare the updated cycle count for the memory device 130 to whichever is the lowest of those one or more cycle-count thresholds that the memory device 130 has yet to reach during its lifetime. If the memory sub-system controller 115 determines at operation 410 that the updated cycle count exceeds the relevant threshold, control passes to operation 412. If not, control returns to operation 404.

At operation 412, the memory sub-system controller 115 instructs the memory device 130 to load the media-settings solution that the memory sub-system controller 115 transmitted to the memory device 130 at operation 402. It is noted that, in other instances, the memory sub-system controller 115 may instruct the memory device 130 at operation 412 to load a different media-settings solution. Furthermore, in some instances, operation 402 is not performed—for example, the media-settings solution could have been provisioned into a read-only block of the memory device 130 at the time of manufacture of, e.g., the memory device 130 or the memory sub-system 110. Responsive to being instructed by the memory sub-system controller 115 at operation 412 to load a media-settings solution, the memory device 130 conducts an internal-read operation to obtain the media-settings solution and loads the obtained media-settings solution as described herein. In at least one embodiment, the memory sub-system controller 115 instructs the memory device 130 at operation 412 to load a media-settings solution that is specifically associated—by the memory sub-system controller 115 and/or the memory device 130—with the cycle-count threshold against which the memory sub-system controller 115 evaluated the updated cycle count in operation 410.

In at least one embodiment, the memory sub-system controller 115 performing operation 302 of the method 300 involves the memory sub-system controller 115 determining that the answer is “Yes” in at least one of operation 404, operation 406, and operation 410. Moreover, in various different embodiments, one or more of operation 404, operation 406, and operation 410 are not present, and in further embodiments, one or more additional decision-box operations are present as criteria used in determining in operation 302 whether a triggering condition is detected for updating one or more media settings of the memory device 130.

Moreover, in at least one embodiment, the memory sub-system controller 115 is configured to perform the method 400 with respect to each of multiple memory devices. In some such embodiments, the memory sub-system controller 115 is configured to proceed through performing the method 400 serially with respect to each of the memory devices present in the memory sub-system 110, and to repeatedly (e.g., periodically) do so. Furthermore, in some implementations, the memory sub-system controller 115 evaluates one or more of the criteria that are evaluated in the method 400 using digital logic that evaluates these criteria in different order and/or using multiple different subprocesses.

Returning now to FIG. 3, at operation 304, responsive to detecting the triggering condition in operation 302, the memory sub-system controller 115 instructs the memory device 130 to load, from data storage on the memory device 130, a set of one or more media-setting values that correspond to one or more media settings of the memory device 130. In some embodiments, step 304 includes the memory sub-system controller 115 transmitting a load-media-settings command to the memory device 130, where the load-media-settings command instructs the memory device 130 to load a media-setting solution from data storage on the memory device 130. In different instances, the data storage on the memory device 130 from which the memory device 130 loads a particular media-setting solution can be the read/write storage 202 or the read-only storage 204. In either case, in at least one embodiment, the memory device 130 is configured to load the particular media-setting solution into the operative settings circuit 206 in the local media controller 135 so as to make the values in the media-setting solution operative for the memory device 130.

A load-media-settings command can be or include an op code or a refresh command, as examples. In at least one embodiment, at least one of the media settings is a non-volatile media setting. The one or more media settings can include one or more read points, one or more temperature-correction coefficients, and/or one or more media settings of any other type mentioned herein and/or deemed suitable by those of skill in the art for a given implementation. Some example media settings are discussed in U.S. Pat. No. 9,147,486, issued Sep. 29, 2015 and entitled “Continuous Adjusting of Sensing Voltages,” U.S. Pat. No. 10,140,040, issued Nov. 27, 2018 and entitled “Memory Device with Dynamic Program-Verify Voltage Calibration,” and U.S. Patent Application Publication No. 2018/0341553 A1, published Nov. 29, 2018 and entitled “Memory Device with Dynamic Target Calibration.”

In at least one embodiment, the memory device 130 is configured to load the set of one or more media-setting values at least in part by performing an internal page-read operation (e.g., a page-read operation that is internal to the memory device 130). Furthermore, the memory device 130 can be further configured to perform at least one of error detection and error correction with respect to the set of one or more media-setting values stored in data storage on the memory device 130. In at least one embodiment in which the memory device 130 is a NAND-type flash device, the media-setting solution is stored in an SLC page on the memory device 130 in a format that is arranged to protect data in the NAND media. As an example, the media-setting solution can be stored in multiple copies and with an inverse of the data as a check of data integrity.

Regardless of the particular storage format that is selected for a given implementation, in general, in at least one embodiment, the media-setting solutions are stored in formats that facilitate the memory device 130 being able to determine whether the media-setting-solution data is corrupted or whether that data can be corrected (in cases in which errors are detected). In at least one embodiment, the memory device 130 is configured to make this determination independently of the memory sub-system controller 115, without the memory device 130 having to, send data back to the memory sub-system controller 115 for analysis and potential correction by way of any ECC technologies available on (or to) the memory sub-system controller 115, e.g., in implementations in which ECC is a responsibility of the memory sub-system 110, perhaps specifically a responsibility of the memory sub-system controller 115.

In at least one embodiment, if the memory sub-system controller 115 and/or the memory device 130 determine that a given media-setting solution that is stored on the memory device 130 is corrupted, the memory sub-system controller 115 identifies and references an earlier media-setting solution for the memory device 130, and proceeds to reapply changes (e.g., read-level updates, other media-setting updates based on cycle count, and/or the like) that occurred since the time that the identified prior media-setting solution had been loaded. By so doing, the memory sub-system controller 115 can, in at least one embodiment, rebuild a non-corrupted copy of the media-setting solution that was determined to be corrupted. To facilitate such embodiments, a portion of a given page (e.g., an SLC page) in which the prior media-setting solution had been stored on the memory device 130 is reserved in at least some embodiments for record-keeping with respect to incremental changes applied to the memory device 130 since the loading of that prior media-setting solution.

In at least some embodiments, then, it is the memory sub-system controller 115 that handles occurrences of media-setting-solution-data corruption on the memory device 130. In at least some such embodiments, the memory sub-system controller 115 also handles the tasks of identifying and managing locations in the memory sub-system 110 in which this media-setting-solution-rebuilding process can occur. This approach to handling occurrences of media-setting-solution data corruption reduces complexity on the memory device 130 and leverages similar error handling/rebuilding routines already implemented at the system level in some current SSD implementations.

In at least one embodiment, the memory sub-system controller 115 receives notification from the memory device 130 of success or failure with respect to the loading by the memory device 130 of a particular set of one or more media-setting values as instructed by the memory sub-system controller 115. The memory device 130 is configured in some implementations, in the event of a failure to load a given media-setting solution, to retain a previously loaded set of media-setting values as its operative set of media-setting values. The memory device 130 can be further configured to set an error code in this event. In some embodiments, if the loading (e.g., internal read) does not happen correctly on the memory device 130, the memory device 130 is configured to indicate to the memory sub-system controller 115 that the loading process is not complete, and to request that the memory sub-system controller 115 respond to the memory device 130, perhaps with further instructions.

In some implementations of the present disclosure, the memory sub-system controller 115 transmits to the memory device 130 a location on the memory device 130 from which the memory device 130 is to load the set of one or more media-setting values. The location can be expressed as a block and page (e.g., a NAND block and page), as one example. In some implementations, the set of one or more media-setting values is stored in a read-only location on the memory device 130. In some instances, the set of one or more media-setting values is stored in an SLC memory-cell location on the memory device 130. In some implementations, media-setting-solution data can be stored with other SLC data. In some instances, the other SLC data can be related to other operational, functional, and/or management functions, perhaps related to power, backup power, and/or one or more other functions.

Multiple sets of media settings are stored in different locations on the memory device 130 in some embodiments. In some such embodiments, the memory sub-system controller 115 transmits to the memory device 130 an identification of which of the stored sets of media settings to load. In some cases, the memory sub-system controller 115 identifies (e.g., by name, identifier, and/or other identifying data) a particular media-setting solution for the memory device 130 to load, and the memory device 130 is configured to map that solution-identifying data to a particular storage location on the memory device 130. Moreover, in at least one embodiment, as part of a single setting-loading process or multiple setting-loading processes, the memory device 130 is configured to load at least one media setting from a first set of media settings stored on the memory device 130 and at least one setting from a second set of media settings stored on the memory device 130.

Moreover, in at least one embodiment, the memory sub-system controller 115 is configured to detect a performance-deviation event with respect to the memory device 130, and responsively (i) access, on the memory device 130, a stored copy of at least one most-recent media setting and (ii) generate a performance-deviation report, that includes the at least one most-recent media setting for the memory device 130. That is, in at least one embodiment, one or more media-setting solutions persist for at least some time after having been loaded; these saved sets of media settings represent information that is potentially useful when investigating performance deviations with respect to the memory device 130. This data can be used to more accurately understand the state and environment of the memory device 130 at the time that the unexpected behavior occurred. In this context, the term performance-deviation event should be understood broadly to encompass any type of event, whether routine, abnormal, or otherwise, deemed by those of skill in the art to warrant analysis, examination, tracking, investigation, and/or the like. One example of such an event is a media error.

In at least one implementation, preset pages (set during manufacture of the memory device 130 or the memory sub-system 110, as examples) contain specific media-setting solutions that are arranged to be loaded in response to detection of various (e.g., expected) conditions in the field. As an example, a media-setting solution that includes values for temperature-correction coefficients and/or read points can be stored for a specific cycle count. The memory sub-system controller 115 can send a predetermined op code to the memory device 130 to instruct the memory device 130 to load the corresponding solution upon the memory device 130 reaching that cycle count. In at least one embodiment, one or more such preset pages are stored in the read-only storage 204 of the memory device 130; in at least one such embodiment, no media-setting solutions are stored in the firmware of the memory sub-system controller 115.

In some embodiments, the memory sub-system controller 115 transmits one or more media-setting solutions to the memory device 130. In at least one such embodiment, the memory sub-system controller 115 is configured to use a write-page operation to do so. In at least one such embodiment, the memory sub-system controller 115 is configured to transmit sets of one or more media-setting values to the memory device 130 during one or more uncongested periods (e.g., periods of relatively low traffic) on the one or more controller channels between the memory sub-system controller 115 and the memory device 130. In some embodiments, storage locations on the memory device 130 in which one or more media-setting solutions are stored are selected during operation of the memory sub-system 110.

In accordance with various different embodiments, different storage strategies and/or formats can be defined for storage of media-setting solutions on the various memory devices 130. As stated, in at least one implementation, one or more full copies of one or more media-setting solutions are stored on one or more of the memory devices 130, along with error-correction information. In some implementations, specific subsets (e.g., groups) of media settings are defined for updating and are saved to a memory device 130 using a mechanism such as transmission of one or more setting/value pairs.

According to one or more implementations, various groups of one or more media-settings can be stored in separate locations on the memory devices 130. As part of any given setting-update operation, one or more such stored groups can be identified and invoked for loading by the memory device 130. Such groups may be delineated according to any suitable paradigm, with one option being by setting type (e.g., settings such as read levels stored in one storage location and other settings such as temperature-correction coefficients by cycle count stored in one or more factory static (e.g., read-only) locations). And certainly other approaches are possible as well. In some cases, a single command can be issued from the memory sub-system controller 115 to a memory device 130 to instruct the memory device 130 to load settings from multiple storage locations on the memory device 130. In other cases, multiple load-media-settings commands are issued by the memory sub-system controller 115 to achieve the same result.

In some embodiments, the memory sub-system controller 115 can issue a particular load-media settings command to instruct the memory device 130 to load a given media-setting solution sent from the memory sub-system controller 115 to the memory device 130 at the same time the solution data is stored by the memory device 130 in a location on the memory device 130. In other instances, the memory sub-system controller 115 may issue a command that instructs the memory device 130 to load a particular media-setting solution sent to the memory device 130 at that time by the memory sub-system controller 115 and to not store the media-setting solution elsewhere on the memory device 130; for example, the command may instruct the memory device 130 to write the media-setting solution to a temporary page buffer on the memory device 130 and to then load the solution from the buffer. In general, read/write times can be asymmetric. In some instances, media-setting solutions can be sent to the memory device 130 for loading by the memory device 130 at a later time.

As described herein, in some embodiments, the memory sub-system 110 includes multiple (e.g., 64) memory devices 130. In at least one such embodiment, the memory sub-system controller 115 is configured to transmit load-media-settings commands to each of the memory devices 130 in the memory sub-system 110, or perhaps to some subset thereof. Each such load-media-settings command instructs the associated memory device 130 to load, from data storage on the memory device 130, a set of one or more media-setting values corresponding to one or more media settings of the memory device 130. In at least one such embodiment, the sets of media-settings values are tailored to specific ones of the memory devices 130. More generally stated, in at least one embodiment, the content of the set of media-setting values for one of the memory devices 130 is different than the content of the set of media-setting values for at least one of the other memory devices 130.

Moreover, in at least one embodiment, the loading by at least one of the memory devices 130 of its corresponding set of media-setting values overlaps in time with the loading by at least one of the other memory devices 130 of its corresponding set of media-setting values. In such embodiments, the efficiency gains of this parallel-loading approach increase as the number of memory devices 130 in the memory sub-system 110 increases.

Moreover, there are also bandwidth and latency gains with respect to adjusting one or more media settings. Implementations of the present disclosure reduce the amount of traffic and therefore the number of expected and actual collisions on the one or more controller channels that connect the memory sub-system controller 115 with the memory devices 130. Moreover, implementations of the present disclosure reduce system (e.g., SSD) boot-up time as well as bus (e.g., controller-channel) contention at least in part by configuring the memory sub-system controller 115 to provide to the memory devices 130 a simple command that points to a location (e.g., an SLC location) on the memory device 130 in which a given media-setting solution is stored, the command instructing the memory device 130 to load that solution from that location. After issuing that command to a given memory device 130, the memory sub-system controller 115 can move on to similarly instructing one or more of the other memory devices 130.

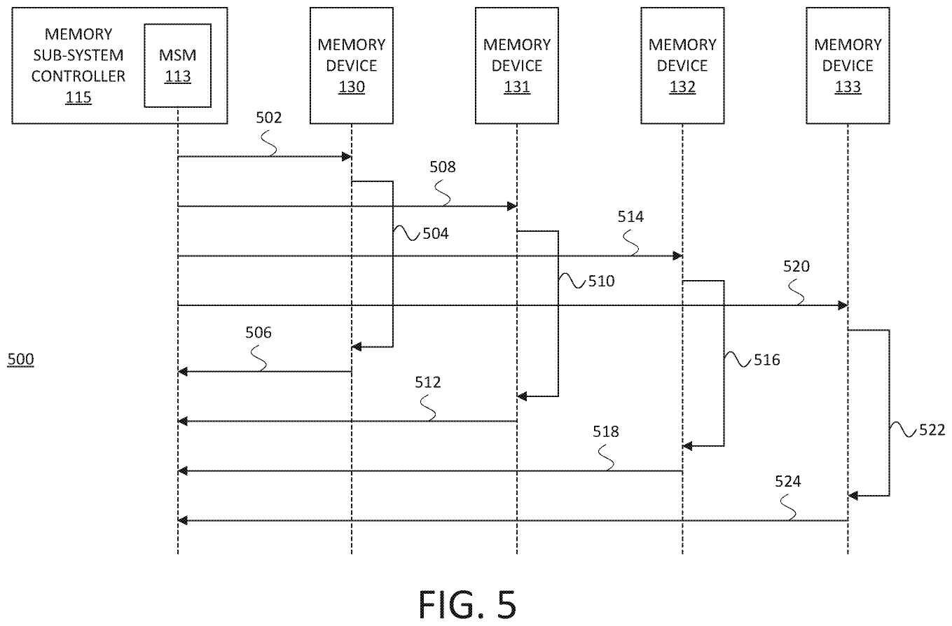

FIG. 5 depicts a message flow 500 that demonstrates aspects of this parallelism that is achieved in at least some implementations of the present disclosure. The message flow 500 includes some example messaging among, and operations performed by, the media settings manager 113 of the memory sub-system controller 115 and multiple memory devices of the memory sub-system 110 including the memory device 130, a memory device 131, a memory device 132, and a memory device 133. The depiction of four memory devices 130-133 is by way of example and not limitation, as any suitable number of memory devices could be present in a given implementation or depicted in a given example illustration.

The message flow 500 begins with the media settings manager 113 transmitting a load-media-settings command 502 to the memory device 130, instructing the memory device 130 to load a particular media-settings solution from data storage on the memory device 130. In some instances, in addition to sending the load-media-settings command, the media settings manager 113 also transmits to the memory device 130 an indication of a location (e.g., a block and page) on the memory device 130 from which the memory device 130 is to load the particular media-setting solution and/or an identification of the particular media-settings solution that the memory device 130 is instructed to internally read and load.

In response to receiving the load-media-settings command 502, the memory device 130 responsively begins an internal read-and-load process 504 to read the particular media-settings solution from data storage on the memory device 130 and then load the media-settings solution. Upon completion (success or failure), the memory device 130 transmits a status message 506 to the media settings manager 113 to indicate the success or failure of the read-and-load process 504.

While the memory device 130 is performing the read-and-load process 504, the media settings manager 113 transmits a load-media-settings command 508 to the memory device 131, a load-media-settings command 514 to the memory device 132, and a load-media-settings command 520 to the memory device 133. In some embodiments, the media settings manager 113 also transmits to one or more of the memory devices 131-133 a location on the memory device 131-133 from which to load its media-settings solution and/or an identification of the media-settings solution on the memory device 131-133.

Responsive to receiving the load-media-settings commands 508, 514, and 520, the memory devices 131, 132, and 133 initiate their own read-and-load processes 510, 516, and 522, respectively. Moreover, the memory devices 131, 132, and 133 report the success or failure of their respective read-and-load processes 510, 516, and 522 by transmitting respective status messages 512, 518, and 524 to the media settings manager 113. As described above, in some implementations, the memory devices 130-133 are configured to handle a failure to load a given media-setting solution by retaining a previously loaded media-setting solution as its operative media-setting solution, and are configured in some embodiments to set an error code as well.

It is noted that the particular overlap in time of the transmission of various messages and the performing of various processes that is depicted in the message flow 500 is by way of example and not limitation, and in general is meant to demonstrate some of the parallelism benefits of implementations of the present disclosure. Moreover, it is further noted that time is not depicted to scale in the message flow 500. Thus, the depicted amounts of time, for example between transmission by the media settings manager 113 of successive ones of the load-media-settings commands 502, 508, 514, and 520 as compared with, for example, the duration of a given one of the read-and-load processes 504, 510, 516, or 522 is not meant to be to scale with respect to time.

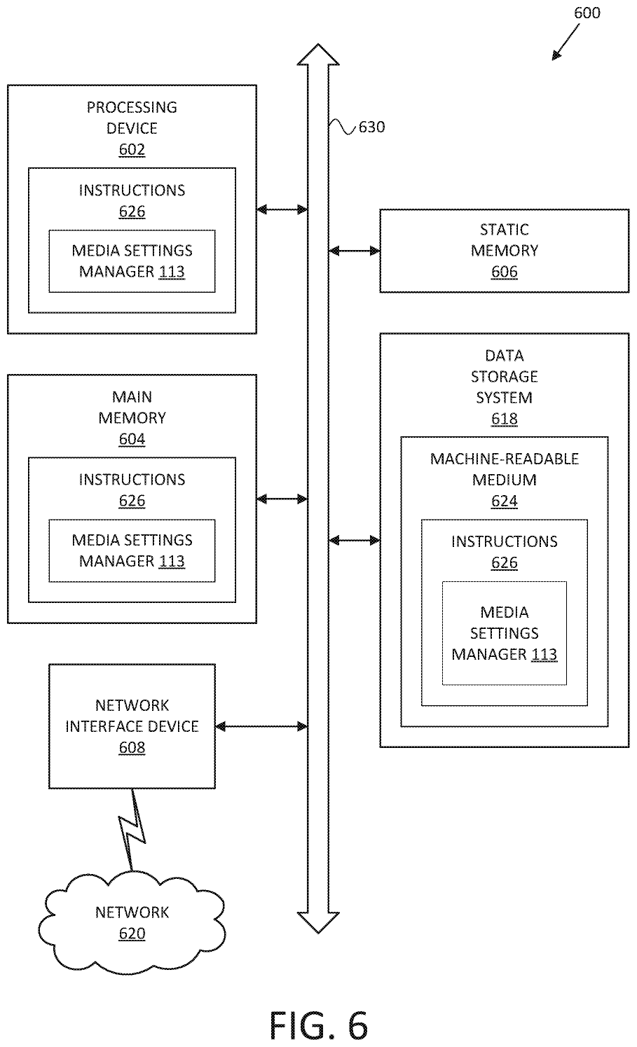

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media settings manager 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or RDRAM, etc.), a static memory 606 (e.g., flash memory, SRAM, etc.), and a data storage system 618, which communicate with each other via a bus 630.

The processing device 602 represents one or more general-purpose processing devices such as a microprocessor, a central processing unit (CPU), or the like. More particularly, the processing device 602 can be a complex instruction set computing (CISC) microprocessor, a reduced instruction set computing (RISC) microprocessor, a very long instruction word (VLIW) microprocessor, or a processor implementing other instruction sets, or processors implementing a combination of instruction sets. The processing device 602 can also be one or more special-purpose processing devices such as an ASIC, an FPGA, a digital signal processor (DSP), a network processor, or the like. In at least one embodiment, the processing device 602 is configured to execute instructions 626 for performing the operations and operations discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In an embodiment, the instructions 626 include instructions to implement functionality corresponding to a media settings manager (e.g., the media settings manager 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed description have been presented in terms of algorithms and symbolic representations of operations on data bits within a computer memory. These algorithmic descriptions and representations are the ways that are used by those skilled in the data-processing arts to most effectively convey the substance of their work to others skilled in such arts. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and/or otherwise manipulated. It has proven convenient at times, principally for reasons of common usage, to refer to these signals as bits, values, elements, symbols, characters, terms, numbers, and/or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within a computer system's registers and memories into other data similarly represented as physical quantities within the computer system's registers and memories or other such information-storage systems.

The present disclosure also relates to an apparatus for performing the operations that are described herein. This apparatus can be specially constructed for the intended purposes, or it can include a general-purpose computer selectively activated or reconfigured by a computer program stored in the computer. Such a computer program can be stored in a computer-readable storage medium such as but not limited to any type of disk including floppy disks, optical disks, CD-ROMs, magnetic-optical disks, ROMs, RAMs, EPROMs, EEPROMs, magnetic or optical cards, and/or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the present disclosure. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic device or devices) to perform a process according to the present disclosure. A machine-readable medium includes any mechanism for storing information in a form readable by a machine (e.g., a computer). In some implementations, a machine-readable (e.g., computer-readable) medium includes a machine-readable (e.g., computer-readable) storage medium such as a ROM, RAM, magnetic disk storage media, optical storage media, flash memory devices, and/or the like.

In the foregoing specification, some example implementations of the disclosure have been described. It will be evident that various modifications can be made thereto without departing from the broader scope and spirit of the disclosure as set forth in the following claims. The specification and drawings are, accordingly, to be regarded in an illustrative sense rather than in a restrictive sense.

Below is a non-exhaustive list of examples.

Example 1 is a system that includes a plurality of memory components and a processing device that is operatively coupled with the plurality of memory components to perform operations including: detecting a triggering condition for updating one or more media settings of a memory component of the plurality of memory components and, responsive to detecting the triggering condition, instructing the memory component to load, from data storage on the memory component, a set of one or more media-setting values that correspond to the one or more media settings of the memory component.

Example 2 is the subject matter of Example 1, where the triggering condition includes elapsing of a recurring timer.

Example 3 is the subject matter of Example 1 or Example 2, where the triggering condition includes the memory component reaching a threshold program/erase-cycle count.

Example 4 is the subject matter of any of the Examples 1-4, where the triggering condition includes the memory component performing a boot-up operation.

Example 5 is the subject matter of any of the Examples 1-5, where instructing the memory component to load, from data storage on the memory component, the set of one or more media-setting values that correspond to the one or more media settings of the memory component includes transmitting a command to the memory component.

Example 6 is the subject matter of any of the Examples 1-6, the operations further including transmitting, to the memory component, a location on the memory component from which the memory component is to load the set of one or more media-setting values.

Example 7 is the subject matter of any of the Examples 1-9, where multiple sets of media settings are stored in different locations on the memory component.

Example 8 is the subject matter of any of the Examples 1-12, the operations further including transmitting the set of one or more media-setting values to the memory component.

Example 9 is the subject matter of any of the Examples 1-15, the operations further including instructing each of the other memory components in the plurality of memory components to load, from data storage on the other memory component, a set of one or more media-setting values corresponding to one or more media settings of the other memory component.

Example 10 is a method including detecting a triggering condition for updating one or more media settings of a memory component of a plurality of memory components and, responsive to detecting the triggering condition, instructing the memory component to load, from data storage on the memory component, a set of one or more media-setting values that correspond to the one or more media settings of the memory component.

Example 11 is the subject matter of Example 10, where the triggering condition includes elapsing of a recurring timer.

Example 12 is the subject matter of Example 10 or Example 11, where the triggering condition includes the memory component reaching a threshold program/erase-cycle count.

Example 13 is the subject matter of any of the Examples 10-12, where the triggering condition includes the memory component performing a boot-up operation.

Example 14 is the subject matter of any of the Examples 10-13, where instructing the memory component to load, from data storage on the memory component, the set of one or more media-setting values that correspond to the one or more media settings of the memory component includes transmitting a command to the memory component.

Example 15 is the subject matter of any of the Examples 10-14, further including transmitting, to the memory component, a location on the memory component from which the memory component is to load the set of one or more media-setting values.

Example 16 is the subject matter of any of the Examples 10-15, where the set of one or more media-setting values is stored in a read-only location on the memory component.

Example 17 is the subject matter of any of the Examples 10-16, where multiple sets of media settings are stored in different locations on the memory component.

Example 18 is the subject matter of any of the Examples 10-17, further including transmitting the set of one or more media-setting values to the memory component.

Example 19 is the subject matter of any of the Examples 10-18, further including instructing each of the other memory components in the plurality of memory components to load, from data storage on the other memory component, a set of one or more media-setting values corresponding to one or more media settings of the other memory component.

Example 20 is a non-transitory machine-readable storage medium containing instructions that, when executed by a processing device, cause the processing device to perform operations including detecting a triggering condition for updating one or more media settings of a memory component of a plurality of memory components, and, responsive to detecting the triggering condition, instructing the memory component to load, from data storage on the memory component, a set of one or more media-setting values that correspond to the one or more media settings of the memory component.

What is claimed is:

1. A system comprising:
a plurality of memory components; and
a processing device, operatively coupled with the plurality of memory, components to perform operations comprising:
detecting a triggering condition for updating one or more media settings of a memory component of the plurality of memory components; and
responsive to detecting the triggering condition, instructing the memory component to load, from data storage on the memory component, a set of one or more media-setting values that correspond to the one or more media settings of the memory component.

2. The system of claim 1, wherein the triggering condition comprises elapsing of a recurring timer.

3. The system of claim 1, wherein the triggering condition comprises the memory component reaching a threshold program/erase-cycle count.

4. The system of claim 1, wherein the triggering condition comprises the memory component performing a hoot-up operation.

5. The system of claim 1, wherein instructing the memory component to load, from data storage on the memory component, the set of one or more media-setting values that correspond to the one or more media settings of the memory component comprises transmitting a command to the memory component.

6. The system of claim 1, the operations further comprising transmitting, to the memory component, a location on the memory component from which the memory component is to load the set of one or more media-setting values.

7. The system of claim 1, wherein multiple sets of media settings are stored in different locations on the memory component.

8. The system of claim 1, the operations further comprising transmitting the set of one or more media-setting values to the memory component.

9. The system of claim 1, the operations further comprising:
instructing each of the other memory components in the plurality of memory components to load, from data storage on the other memory component, a set of one or more media-setting values corresponding to one or more media settings of the other memory component.

10. A method comprising:
detecting a triggering condition for updating one or more media settings of a memory component of a plurality of memory components; and
responsive to detecting the triggering condition, instructing the memory component to load, from data storage on the memory component, a set of one or more media-setting values that correspond to the one or more media settings of the memory component.

11. The method of claim 10, wherein the triggering condition comprises elapsing of a recurring tinier.

12. The method of claim 10, wherein the triggering condition comprises the memory component reaching a threshold program/erase-cycle count.

13. The method of claim 10, wherein the triggering condition comprises the memory component performing a boot-up operation.

14. The method of claim 10, wherein instructing the memory component to load, from data storage on the memory component, the set of one or more media-setting values that correspond to the one or more media settings of the memory component comprises transmitting a command to the memory component.

15. The method of claim 10, further comprising transmitting, to the memory component, a location on the memory component from which the memory component is to load the set of one or more media-setting values.

16. The method of claim 10, wherein the set of one or more media-setting values is stored in a read-only location on the memory component.

17. The method of claim 10, wherein multiple sets of media settings are stored in different locations on the memory component.

18. The method of claim 10, further comprising transmitting the set of one or more media-setting values to the memory component.

19. The method of claim 10, further comprising:
instructing each of the other memory components in the plurality of memory components to load, from data storage on the other memory component, a set of one or more media-setting values corresponding to one or more media settings of the other memory component.

20. A non-transitory machine-readable storage medium containing instructions that, when executed by a processing device, cause the processing device to perform operations comprising:
detecting a triggering condition for updating one or more media settings of a memory component of a plurality of memory components; and
responsive to detecting the triggering condition, instructing the memory component to load, from data storage on the memory component, a set of one or more media-setting values that correspond to the one or more media settings of the memory component.
